(19) United States
(12) Patent Application Publication
(10) Pub. No.: US 2025/0287234 A1
(43) Pub. Date: Sep. 11, 2025

(54) DATASET IDENTIFICATION FOR ARTIFICIAL INTELLIGENCE AND/OR MACHINE LEARNING AIR INTERFACE USE CASES

(71) Applicant: QUALCOMM Incorporated, San Diego, CA (US)

(72) Inventors: Mohammed Ali Mohammed HIRZALLAH, San Marcos, CA (US); Taesang YOO, San Diego, CA (US); Jay Kumar SUNDARARAJAN, San Diego, CA (US)

(21) Appl. No.: 18/598,604

(22) Filed: Mar. 7, 2024

(51) Int. Cl. H04W 24/08; H04W 28/02

(52) U.S. Cl. CPC H04W 24/08; H04W 28/0205

(57) ABSTRACT

Various aspects of the present disclosure generally relate to wireless communication. In some aspects, a user equipment (UE) may collect a dataset during a data collection session associated with an artificial intelligence or machine learning (AI/ML) air interface use case. The UE may receive, from a network node, a dataset identifier assigned to the data collection session associated with the AI/ML air interface use case. The UE may associate the dataset identifier with the dataset and with one or more configurations associated with the UE during the data collection session. Numerous other aspects are described.

### FIELD OF THE DISCLOSURE

Aspects of the present disclosure generally relate to wireless communication and specifically relate to techniques, apparatuses, and methods associated with dataset identification for artificial intelligence and/or machine learning air interface use cases.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include collecting a dataset during a data collection session associated with an artificial intelligence or machine learning (AI/ML) air interface use case. The method may include receiving, from a network node, a dataset identifier assigned to the data collection session associated with the AI/ML air interface use case. The method may include associating the dataset identifier with the dataset and with one or more configurations associated with the UE during the data collection session.

Some aspects described herein relate to a UE for wireless communication. The UE may include one or more memories and one or more processors coupled to the one or more memories. The one or more processors may be configured to collect a dataset during a data collection session associated with an AI/ML air interface use case. The one or more processors may be configured to receive, from a network node, a dataset identifier assigned to the data collection session associated with the AI/ML air interface use case. The one or more processors may be configured to associate the dataset identifier with the dataset and with one or more configurations associated with the UE during the data collection session.

Some aspects described herein relate to an apparatus for wireless communication. The apparatus may include means for collecting a dataset during a data collection session associated with an AI/ML air interface use case. The apparatus may include means for receiving, from a network node, a dataset identifier assigned to the data collection session associated with the AI/ML air interface use case. The apparatus may include means for associating the dataset identifier with the dataset and with one or more configurations associated with the apparatus during the data collection session.

Some aspects described herein relate to a non-transitory computer-readable medium that stores a set of instructions for wireless communication by a UE. The set of instructions, when executed by one or more processors of the UE, may cause the UE to collect a dataset during a data collection session associated with an AI/ML air interface use case. The set of instructions, when executed by one or more processors of the UE, may cause the UE to receive, from a network node, a dataset identifier assigned to the data collection session associated with the AI/ML air interface use case. The set of instructions, when executed by one or more processors of the UE, may cause the UE to associate the dataset identifier with the dataset and with one or more configurations associated with the UE during the data collection session.

Some aspects described herein relate to a method of wireless communication performed by a network node. The method may include assigning a dataset identifier to a dataset collected during a data collection session associated with an AI/ML air interface use case. The method may include transmitting, to a UE, the dataset identifier. The method May include associating the dataset identifier with the dataset and with one or more configurations associated with the network node during the data collection session.

Some aspects described herein relate to a network node for wireless communication. The network node may include one or more memories and one or more processors coupled to the one or more memories. The one or more processors may be configured to assign a dataset identifier to a dataset collected during a data collection session associated with an AI/ML air interface use case. The one or more processors may be configured to transmit, to a UE, the dataset identifier. The one or more processors may be configured to associate the dataset identifier with the dataset and with one or more configurations associated with the network node during the data collection session.

Some aspects described herein relate to an apparatus for wireless communication. The apparatus may include means for assigning a dataset identifier to a dataset collected during a data collection session associated with an AI/ML air interface use case. The apparatus may include means for transmitting, to a UE, the dataset identifier. The apparatus may include means for associating the dataset identifier with the dataset and with one or more configurations associated with the apparatus during the data collection session.

Some aspects described herein relate to a non-transitory computer-readable medium that stores a set of instructions for wireless communication by a network node. The set of instructions, when executed by one or more processors of the network node, may cause the network node to assign a dataset identifier to a dataset collected during a data collection session associated with an AI/ML air interface use case. The set of instructions, when executed by one or more processors of the network node, may cause the network node to transmit, to a UE, the dataset identifier. The set of instructions, when executed by one or more processors of the network node, may cause the network node to associate the dataset identifier with the dataset and with one or more configurations associated with the network node during the data collection session.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example architecture of a functional framework for radio access network (RAN) intelligence enabled by data collection, in accordance with the present disclosure.

FIG. 5 is a diagram illustrating examples of artificial intelligence or machine learning (AI/ML) air interface use cases, in accordance with the present disclosure.

FIG. 6 is a diagram illustrating an example associated with dataset identification for AI/ML air interface use cases, in accordance with the present disclosure.

FIG. 7 is a flowchart illustrating an example process performed, for example, by a UE, in accordance with the present disclosure.

FIG. 8 is a flowchart illustrating an example process performed, for example, by a network node, in accordance with the present disclosure.

FIGS. 9-10 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some cases, an artificial intelligence (AI) program, such as a program that includes a machine learning (ML) or artificial neural network (ANN) model, may be configured to provide computing capabilities for wireless communication. For example, an ML model may include representations or may define computing capabilities for making inferences from input data based on patterns or relationships identified in the input data. As described herein, inferences can include one or more decisions, predictions, determinations, and/or values, which may represent outputs of the ML model. The computing capabilities may be defined in terms of certain parameters of the ML model, such as weights and biases. Weights may indicate relationships between certain input data and certain outputs of the ML model, and biases are offsets that may indicate starting points for outputs of the ML model. An example ML model operating on input data may start at an initial output based on the biases and then update the output based on a combination of the input data and the weights.

In a wireless communication context, ML models may be deployed in one or more devices (e.g., a network node and/or a user equipment (UE)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communication devices, networks, or services. For example, an ML model may be utilized for supporting or improving aspects such as mobility management, signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management (OAM) functions, and/or security, among other examples. Furthermore, in cases where radio access network (RAN) intelligence is enabled using AI/ML techniques, a wireless network may support backhaul signaling to support use cases that are based on AI/ML techniques.

Accordingly, as described herein, a RAN may support an AI/ML air interface, where a UE and/or a network node use trained AI/ML models to implement an AI/ML air interface use case (e.g., beam prediction, channel state information (CSI) feedback prediction and compression/decompression, or the like). In some cases, when a wireless node (e.g., a UE and/or a network node) performs inferencing or otherwise uses a model to support an AI/ML-based air interface use case, the wireless node may collect one or more datasets during one or more data collection sessions, and the one or more datasets may be used to monitor or evaluate the model performance and/or to train or retrain the model. In this way, the model may be linked or otherwise associated with the one or more datasets that are used to train or retrain the model. Furthermore, in order to ensure consistency between training and an output from the model when used for inferencing, the model should be associated with one or more related configurations (e.g., UE and/or network node configurations), radio statistics, and/or other information related to a context in effect when the one or more datasets were collected. However, aligning UE and network node configurations and other related conditions poses various challenges.

For example, conditions at a site where an AI/ML use case is implemented, or a scenario in which an AI/ML use case is implemented, may change due to a network node changing one or more configurations, such as beam assignments, beam shapes, and/or transmit powers, among other examples. Although some of the configurations of the network node may be indicated to a UE to enable access link communication, some configurations that are used by the network node may not be indicated, conveyed, or otherwise exposed to the UE (e.g. to reduce signaling overhead, protect proprietary information, or for other suitable reasons). Similarly, there may be one or more UE configurations that are in effect during a data collection session that are not indicated, conveyed, or otherwise exposed to the network node (e.g., an antenna pattern or configuration, an uplink multi-layer precoder, or the like). Additionally, or alternatively, the conditions associated with AI/ML use cases and the related datasets may include the radio characteristics associated with a wireless channel, which can experience significant changes due to movement or mobility of background objects in the environment (e.g., blockers and/or reflectors) and/or other factors. However, when a new UE moves to the site, the UE may need a lengthy time to accurately profile the actual radio characteristics (e.g., due to a lengthy time being needed to collect a sufficiently large number of measurements). Accordingly, because the UE and/or the network node may train one or more models using the collected datasets, the data collection sessions should scope the datasets to be structured and organized according to different contexts (e.g., network node configurations, UE configurations, and/or radio characteristics) in effect when the datasets were collected. However, matching the correct model to the correct context may pose challenges when a UE trains a UE-side model and/or a network node trains a network-side model without indicating, conveying, or otherwise exposing certain configurations that were in effect when the dataset(s) used to train the model(s) were collected.

Various aspects relate generally to techniques to identify datasets associated with AI/ML air interface use cases such that a UE can match UE configurations that were in effect during a data collection session with network node configurations and/or radio characteristics that were in effect during the data collection session without the network conde configurations having to be explicitly indicated, conveyed, or otherwise exposed to the UE and without the UE having to spend significant time characterizing the underlying radio characteristics. Furthermore, some aspects similarly enable the network node to match the network node configurations that were in effect during the data collection session with the UE configurations that were in effect during the data collection session without the UE having to explicitly indicate, convey, or otherwise expose the UE configurations to the network node. For example, some aspects described herein relate to techniques to index, mark, or otherwise associate a dataset collected during a data collection session with a dataset identifier that can then be used to enable coordination between a UE and a network node for one or more lifecycle management (LCM) actions associated with an AI/ML air interface use case (e.g., selecting, activating, deactivating, switching, and/or fallback).

For example, the UE may indicate, to the network node, support for an AI/ML model and/or function (e.g., beam prediction) trained using a dataset associated with a dataset identifier X, and the network node can then request that the UE activate the AI/ML model when the network node uses configurations that match the network node configurations that were in effect when the dataset identifier X was assigned. In another example, the network may indicate, to the UE, that the network node uses a network-side model and/or function (e.g., a decoder for reconstructing compressed CSI feedback) that is trained using a dataset associated with a dataset identifier Y, and the UE can then activate an AI/ML model and/or apply UE configurations that are a closest match to the conditions, scenarios, and/or other context in effect when the dataset identifier Y was assigned. Furthermore, in some cases, the network node (including one or more associated cells) may have a fixed location, whereby the network node may be well-suited to track an environment associated with a wireless channel and characterize changes in the underlying radio characteristics or conditions. Accordingly, in some aspects, the network node may indicate, to the UE, the radio characteristics or conditions that were in effect when a dataset identifier was assigned, such that the UE can associate the dataset identifier (and the corresponding dataset and/or model) with the radio characteristics or conditions in effect when the dataset identifier was assigned. In this way, some aspects described herein may enable a UE and/or a network node to match a model to a context associated with a dataset used to train the model without having to explicitly indicate, convey, or otherwise expose all relevant configurations that were in effect when the dataset was collected.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or AI/ML, among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

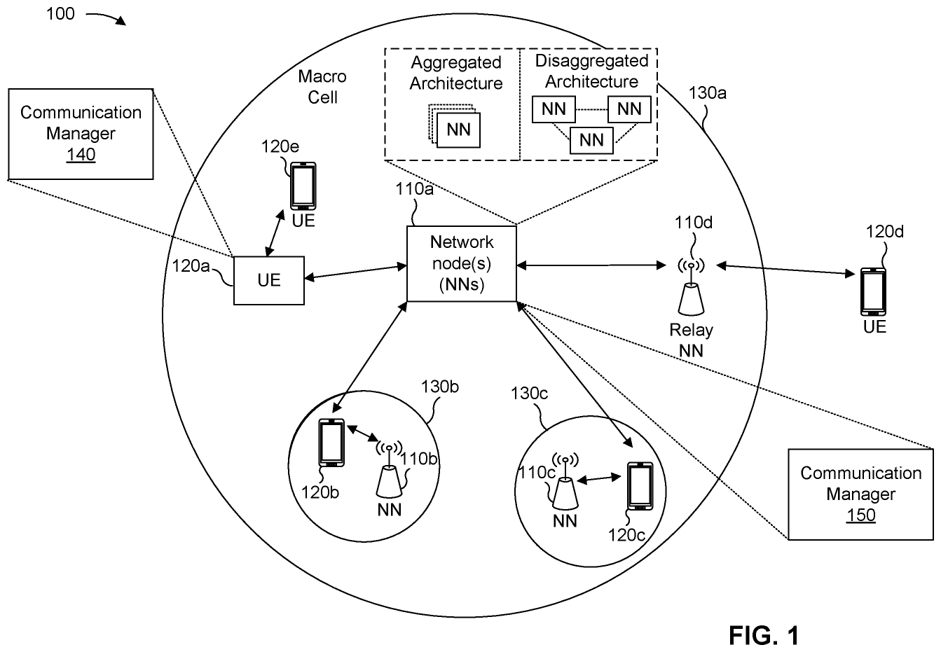

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a RAN.

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which May include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Additionally, or alternatively, MIMO may support simultaneous transmission of multiple layers and/or multiple data streams to a single receivers, referred to as single-user MIMO (SU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may collect a dataset during a data collection session associated with an AI/ML air interface use case; receive, from a network node 110, a dataset identifier assigned to the data collection session associated with the AI/ML air interface use case; and associate the dataset identifier with the dataset and with one or more configurations associated with the UE 120 during the data collection session. Additionally, or alternatively, the communication manager 140 may perform one or more other operations described herein.

In some aspects, the network node 110 may include a communication manager 150. As described in more detail elsewhere herein, the communication manager 150 may assign a dataset identifier to a dataset collected during a data collection session associated with an AI/ML air interface use case; transmit, to a UE 120, the dataset identifier; and associate the dataset identifier with the dataset and with one or more configurations associated with the network node during the data collection session. Additionally, or alternatively, the communication manager 150 may perform one or more other operations described herein.

As indicated above, FIG. 1 is provided as an example. Other examples may differ from what is described with regard to FIG. 1.

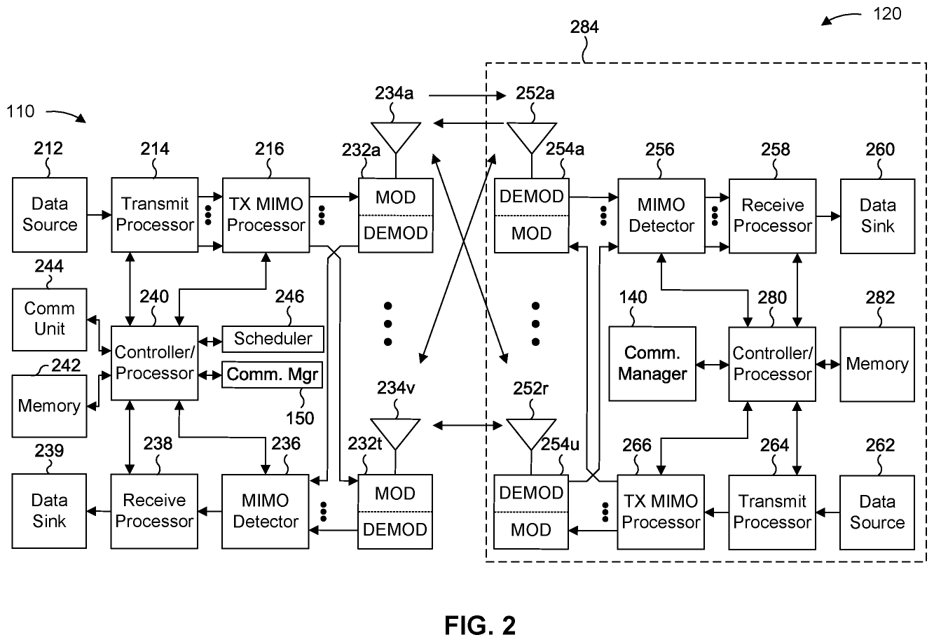

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI reference signal (CSI-RS)) and/or synchronization signals (for example, a primary synchronization signal (PSS) or a secondary synchronization signals (SSS)). The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a signal-to-interference-plus-noise ratio (SINR) parameter, a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

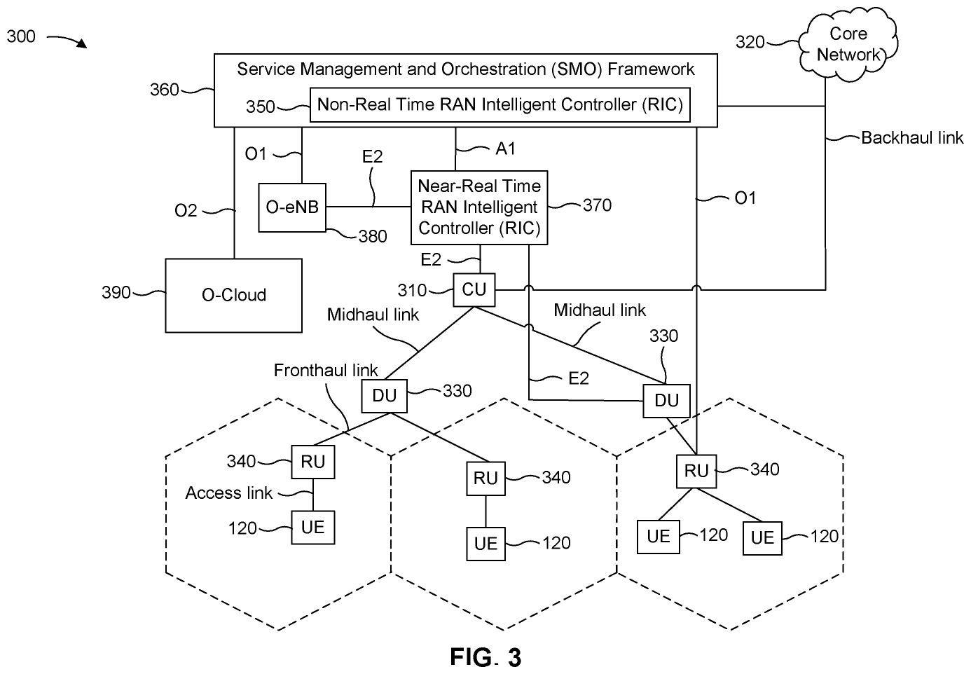

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

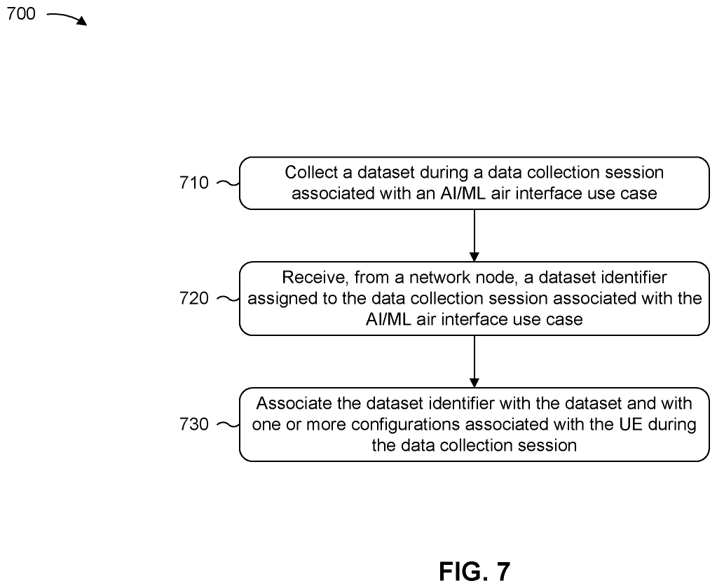

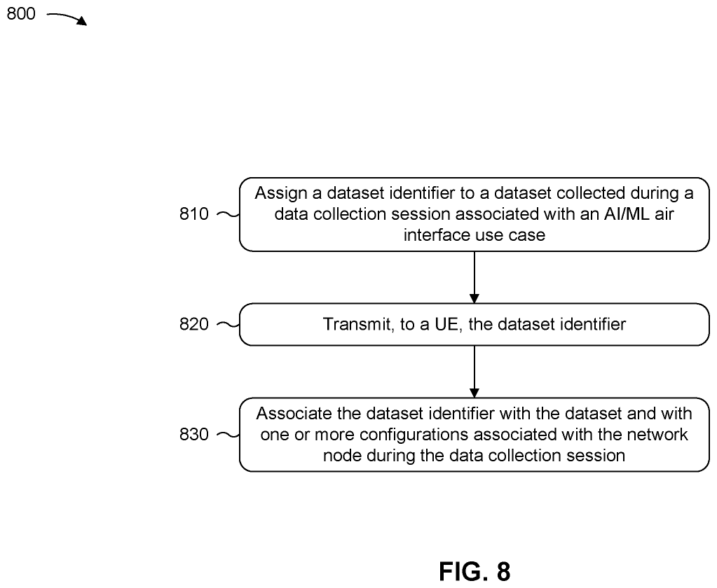

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with dataset identification for AI/ML air interface use cases, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, the UE 120 includes means for collecting a dataset during a data collection session associated with an AI/ML air interface use case; means for receiving, from a network node 110, a dataset identifier assigned to the data collection session associated with the AI/ML air interface use case; and/or means for associating the dataset identifier with the dataset and with one or more configurations associated with the UE during the data collection session. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for assigning a dataset identifier to a dataset collected during a data collection session associated with an AI/ML air interface use case; means for transmitting, to a UE 120, the dataset identifier; and/or means for associating the dataset identifier with the dataset and with one or more configurations associated with the network node during the data collection session.

The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

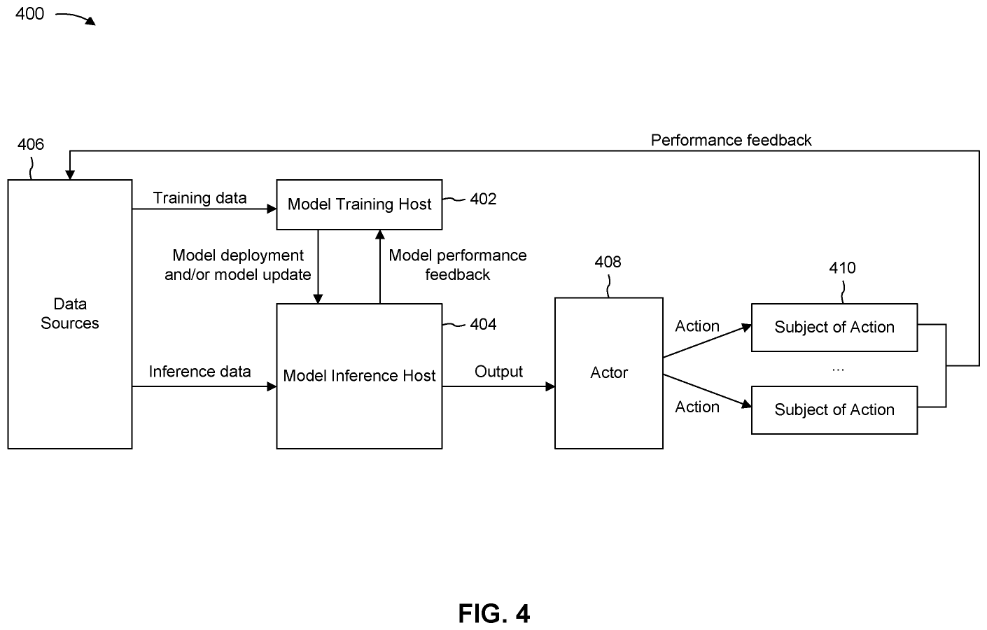

FIG. 4 is a diagram illustrating an example architecture 400 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 400, a functional framework for RAN intelligence may include multiple logical entities, such as a model training host 402, a model inference host 404, data sources 406, and an actor 408.

The model inference host 404 may be configured to run an AI/ML model based on inference data provided by the data sources 406, and the model inference host 404 may produce an output (e.g., a prediction) with the inference data input to the actor 408. The actor 408 may be an element or an entity of a core network or a RAN. For example, the actor 408 may be a UE, a network node, base station (e.g., a gNB), a CU, a DU, and/or an RU, among other examples. In addition, the actor 408 may also depend on the type of tasks performed by the model inference host 404, type of inference data provided to the model inference host 404, and/or type of output produced by the model inference host 404. For example, if the output from the model inference host 404 is associated with position determination, the actor 408 may be a UE, a DU or an RU. In some examples, the model inference host 404 may be hosted on the actor 408. For example, a UE may be the actor 408 and may host the model inference host 404. In some aspects, a UE (e.g., the actor 408) may be a data source 406. For example, the UE may perform a measurement (e.g., an NR measurement), may input the measurement to the AI/ML model at the model inference host 404 (or may provide the measurement to the model inference host 404), and may act based on an output of the AI/ML model.

After the actor 408 receives an output from the model inference host 404, the actor 408 may determine whether to act based on the output. For example, if the actor 408 is a UE and the output from the model inference host 404 is associated with position information, the actor 408 may determine whether to report the position information, reconfigure a beam, among other examples. If the actor 408 determines to act based on the output, in some examples, the actor 408 may indicate the action to at least one subject of action 410.

The data sources 406 may also be configured for collecting data that is used as training data for training an AI/ML model or as inference data for feeding an AI/ML model inference operation. For example, the data sources 406 may collect data from one or more core network and/or RAN entities, which may include the actor 408 or the subject of action 410, and provide the collected data to the model training host 402 for ML model training. In some aspects, the model training host 402 may be co-located with the model inference host 404 and/or the actor 408. For example, the actor 408 or the subject of action 410 may provide performance feedback associated with the beam configuration to the data sources 406, where the performance feedback may be used by the model training host 402 for monitoring or evaluating the AI/ML model performance, such as whether the output (e.g., prediction) provided to the actor 408 is accurate. In some examples, the model training host 402 may monitor or evaluate AI/ML model performance using a training position value, which may be provided by a node (e.g., a UE 120 or a network node 110). In some examples, if the output provided by the actor 408 is inaccurate (or the accuracy is below an accuracy threshold), then the model training host 402 may determine to modify or retrain the AI/ML model used by the model inference host, such as via an AI/ML model deployment/update.

As indicated above, FIG. 4 is provided as an example. Other examples may differ from what is described with regard to FIG. 4.

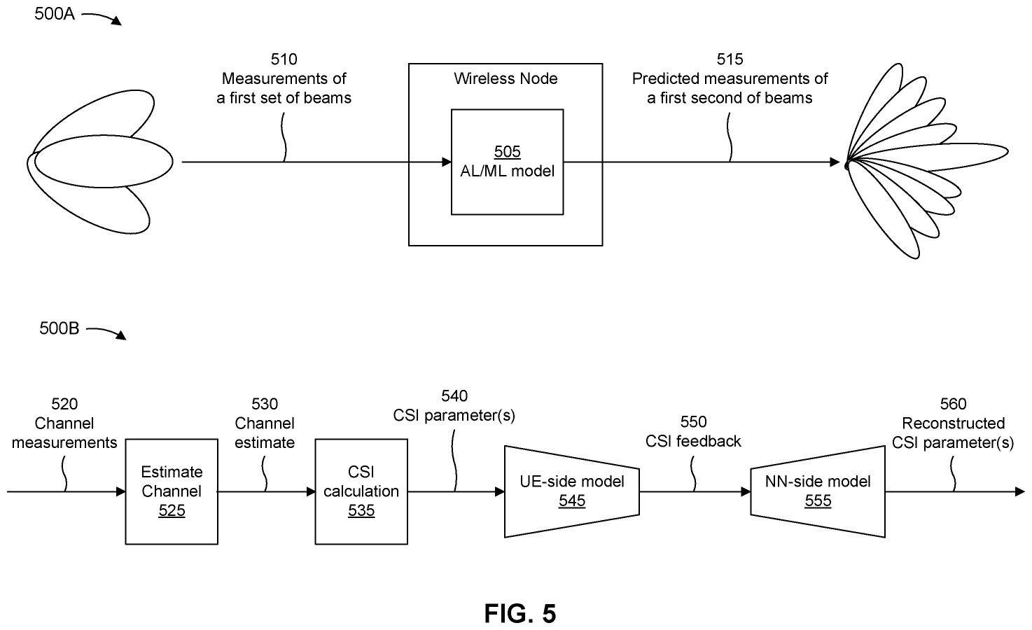

FIG. 5 is a diagram illustrating examples 500A and 500B of AI/ML air interface use cases, in accordance with the present disclosure.

More particularly, example 500A corresponds to an AI/ML-based beam management use case. As shown in FIG. 5, an AI/ML model 505 may be deployed at or on a wireless node, which may correspond to a UE 120 and/or a network node 110. For example, a model inference host may be deployed at, or on, a UE 120, for use in generating one or more UE-side predictions that may be indicated in a prediction report sent to a network node, or the model inference host may be deployed at, or on, a network node 110, for use in generating one or more network-side predictions that may be indicated in a prediction results indication sent to a UE. In some aspects, as described herein, the AI/ML model 505 may enable the wireless node to determine one or more inferences or predictions based on data input to the AI/ML model 505.

For example, as shown by reference number 510, an input to the AI/ML model 505 may include measurements associated with a first set of beams. For example, a network node 110 may transmit one or more signals using respective beams from the first set of beams. The UE 120 may perform measurements (e.g., L1-RSRP measurements, L1-SINR measurements, L3-RSRP measurements, L3-SINR measurements, or other suitable measurements) of the first set of beams to obtain a first set of measurements. For example, each beam, from the first set of beams, may be associated with one or more measurements performed by the UE 120. The UE 120 may input the first set of measurements (e.g., L1/RSRP/L1-SINR and/or L3-RSRP/L3-SINR measurement values) into the AI/ML model 505 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 515, the AI/ML model 505 may output one or more predictions. The one or more predictions may include predicted measurement values (e.g., predicted L1-RSRP/L1-SINR and/or L3-RSRP/L3-SINR measurement values) associated with the second set of beams. This may reduce a quantity of beam measurements that are performed by the UE 120, thereby conserving power of the UE 120 and/or network resources that would have otherwise been used to measure all beams included in the first set of beams and the second set of beams. This type of prediction may be referred to as a codebook-based spatial domain prediction.

As another example, an output of the AI/ML model 505 may include a point-direction, an angle of departure (AoD), and/or an angle of arrival (AoA) of a beam included in the second set of beams. This type of prediction may be referred to as a non-codebook-based spatial domain prediction. As another example, multiple measurement report or values, collected at different points in time, may be input to the AI/ML model 505. This may enable the AI/ML model 505 to output codebook-based and/or non-codebook-based predictions for a measurement value, an AoD, and/or an AoA, among other examples, of a beam at a future time. The output(s) of the AI/ML model 505, as described herein, may facilitate initial access procedures, secondary cell group (SCG) setup procedures, beam refinement procedures (e.g., a P2 beam management procedure or a P3 beam management procedure), link quality or interference adaptation procedures, beam failure and/or beam blockage predictions, and/or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., SSBs, unrefined beams, or other beams having a beam width that satisfies a first threshold) and the second set of beams (e.g., the Set A beams) may include narrow beams (e.g., CSI-RS beams, refined beams, or other beams having a beam width that satisfies a second threshold). In one example, the AI/ML model 505 may be used to perform spatial-domain downlink beam prediction for beams included in the Set A beams based on measurement results of beams included in the Set B beams. As another example, the AI/ML model 505 may be used to perform temporal downlink beam prediction for beams included in the Set A beams based on historic measurement results of beams included in the Set B beams. In cases where the AI/ML model 505 is used to perform temporal downlink beam prediction, the Set A beams may be the same as the Set B beams (e.g., for pure temporal beam prediction), or the Set A beams may be different from the Set B beams (e.g., with or without overlap, to enable spatial and temporal beam prediction). In general, as described herein, the AL/ML model 505 may be used for spatial and/or temporal beam prediction at a network node 110 or a UE 120, and may be supported for single-cell scenarios.

Furthermore, in some cases, beam measurements that are predicted using AI/ML techniques may be used to enable AI/ML-assisted mobility, which may be referred to herein as predictive mobility, or the like. For example, in a lower-layer triggered mobility (LTM) spatial prediction use case, a UE 120 may obtain measurements (e.g., L1-RSRP and/or L1-SINR measurements) for a first set of cross-cell (or inter-cell) SSBs, which may then be used to predict L1-RSRP, L1-SINR, and/or other suitable measurements for a second set of cross-cell (or inter-cell) SSBs. In such cases, the predicted measurements for the second set of cross-cell (or inter-cell) SSBs may be used to make mobility decisions and thereby reduce power consumption at the UE 120 and/or measurement latency in cases where there are a large number of cross-cell beams. In another example, in an LTM temporal prediction use case, a UE 120 may obtain measurements (e.g., L1-RSRP, L1-SINR, and/or other suitable measurements) for a first set of cross-cell (or inter-cell) SSBs, which may then be used to predict measurements for a second set of cross-cell (or inter-cell) CSI-RS beams or other narrow beams for future occasions. In such cases, the predicted measurements for the second set of cross-cell (or inter-cell) CSI-RS or other narrow beams may be used to make mobility decisions (e.g., taking into consideration one or more triggering conditions for conditional LTM based on UE-side temporal beam prediction results) and reduce LTM latency and/or avoid service interruptions (e.g., for inter-DU handovers and/or a non-ideal backhaul).

As further shown in FIG. 5, example 500B corresponds to an AI/ML air interface use case in which a UE 120 and a network node 110 use paired models to encode and decode CSI feedback. For example, as described herein, ML models may be deployed on one or more devices in a wireless network (e.g., a network node 110 and/or a UE 120) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communication devices, networks, or services. For example, an ML model may be utilized for supporting or improving aspects such as mobility management, signal coding/decoding, network routing, energy conservation, transceiver circuitry controls, frequency synchronization, timing synchronization, channel state estimation, channel equalization, channel state feedback, modulation, demodulation, device positioning, beamforming, load balancing, OAM functions, and/or security, among other examples.

Accordingly, as described herein, a RAN may support an AI/ML-based air interface, where a UE 120 and a network node 110 use trained AI/ML models to implement a function. In FIG. 5, example 500B corresponds to a use case where trained AI/ML models are used when a UE 120 conveys CSI feedback (e.g., a precoder, a precoding matrix, and/or a rank that the UE 120 prefers, based on an observed channel, a CQI, and/or a channel matrix) to a network node 110. For example, as shown in FIG. 5, the UE may obtain channel measurements 520 (e.g., based on measurements associated with one or more CSI-RSs or other suitable signals). As shown by reference number 525, the UE 120 may then estimate a channel associated with the channel measurements 520. For example, the UE 120 may obtain a channel estimate 530 that is represented as a matrix with entries associated with reception parameters for different frequencies and/or times as measured from one or more CSI-RSs or other suitable signals. As shown by reference number 535, the UE 120 may calculate one or more CSI parameters 540 such as a precoder (or precoding matrix) associated with the channel estimate 530. For example, the UE may perform singular value decomposition (SVD) using the channel estimate to calculate the one or more CSI parameters 540. In some aspects, the UE 120 may input the one or more CSI parameters 540 to an encoder. For example, as shown in FIG. 5, the UE 120 may use a UE-side model 545 (e.g., a first neural network or other AI/ML model) to derive compressed CSI feedback 550 (e.g., a compressed representation of the one or more CSI parameters 540). As shown in FIG. 5, the compressed CSI feedback 550 may be transmitted to the network node 110, and the network node 110 may use a network-side model 555 (e.g., a second neural network or other AI/ML model) to obtain one or more reconstructed CSI parameters 560 and/or other suitable wireless communication parameters from the compressed CSI feedback 550. For the reconstruction to be accurate, the UE-side model 545 and the network-side model 555 should be trained in a collaborative manner such that the compressed representation of the CSI feedback 550 created by the UE-side model 545 is interpreted and decoded correctly by the network-side model 555. When this condition is satisfied, the pair of models are considered to be compatible.

As indicated above, FIG. 5 is provided as an example. Other examples may differ from what is described with regard to FIG. 5.

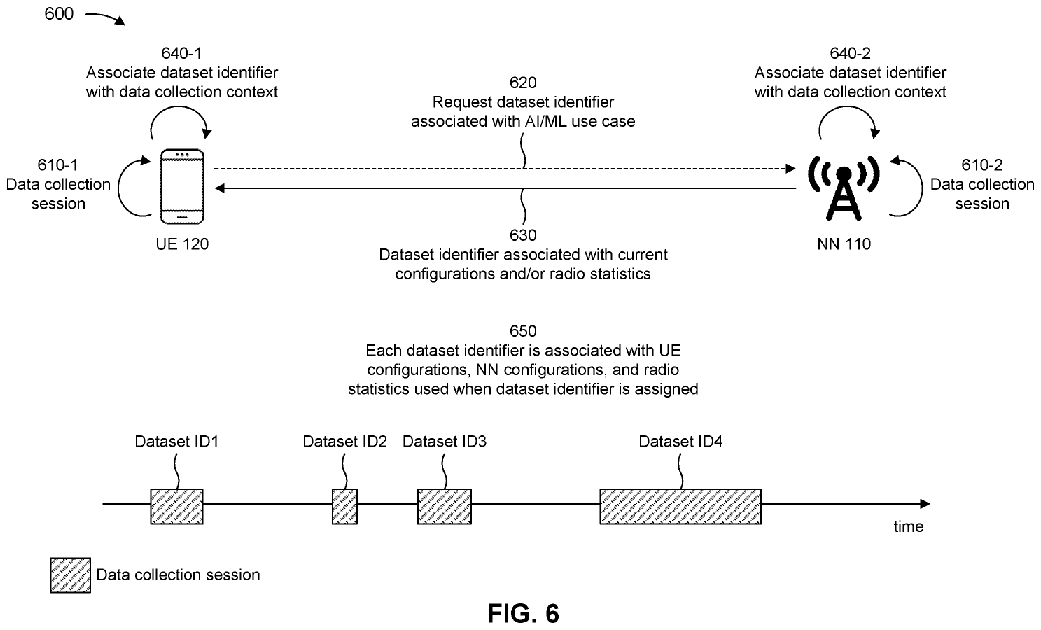

FIG. 6 is a diagram illustrating an example 600 associated with dataset identification for AI/ML air interface use cases, in accordance with the present disclosure. As shown in FIG. 6, example 600 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink. In some aspects, the network node 110 and/or the UE 120 may train one or more models and/or may use one or more models for inferencing to implement an AI/ML air interface use case.

As shown in FIG. 6, and by reference numbers 610-1 and 610-2, the UE 120 and/or the network node 110 may collect a dataset during a data collection session. For example, as described herein, the dataset may include any suitable data related to a context associated with an AI/ML air interface use case, such as beam prediction, CSI prediction and compression, mobility management, signal coding/decoding, network routing, energy conservation, transceiver circuitry controls, frequency synchronization, timing synchronization, channel state estimation, channel equalization, channel state feedback, modulation, demodulation, device positioning, beamforming, load balancing, OAM functions, and/or security, among other examples. For example, as described herein, the dataset may be collected for use in training or retraining one or more models associated with the AI/ML use case and/or for monitoring or evaluating performance of one or more models associated with the AI/ML use case, among other examples.

In some aspects, the data collection session may be active and running only at the UE 120, only at the network node 110, or at the UE 120 and the network node 110. For example, in some aspects, the dataset that is collected during the data collection session may relate to a beam prediction AI/ML use case implemented only at the UE 120 (e.g., using measurements that the UE 120 obtained for a first set of beams to predict measurements associated with a second set of beams). In another example, the dataset that is collected during the data collection session may relate to an AI/ML use case that is implemented only at the network node 110 to support OAM functions. In another example, the UE 120 and the network node 110 may collect respective datasets related to a two-sided AI/ML use case that is implemented at the UE 120 and the network node 110, such as CSI prediction, compression, and reconstruction. In some aspects, the dataset(s) may be collected by the UE 120 and/or the network node 110 according to implementations (e.g., proprietary configurations) of the UE 120 and/or the network node 110, and each node may be aware or unaware of the data collection session being performed at the other node (e.g., a data collection session at the UE 120 may be visible or transparent to the network node 110, and vice versa). Accordingly, some aspects described herein relate to techniques to index, mark, or otherwise assign a dataset identifier to a dataset collected by the UE 120 and/or the network node 110, such that each node may be aware when data collection is active at the other node in a time occasion or other suitable time period. In this way, the dataset identifier that is assigned to a dataset may provide the UE 120 and the network node 110 with an annotation that can be used to track configurations and radio statistics over time and to apply certain configurations and/or LCM actions for an AI/ML air interface use case.

In some aspects, as described herein, the UE 120 or the network node 110 may initiate a process to index, mark, or otherwise annotate a dataset associated with an AI/ML air interface use case to enable one or more LCM actions for the AI/ML air interface use case. For example, as shown by reference number 620, the UE 120 may transmit, and the network node 110 may receive, a request to assign a dataset identifier associated with a data collection session performed at the UE 120. In such cases, the UE 120 may be associated with a dataset that the UE 120 is collecting in association with a UE-side model or a UE-part of a two-sided model associated with an AI/ML air interface use case. In some aspects, as shown by reference number 630, the network node 110 may then assign the dataset identifier and then transmit, to the UE 120, information indicating the dataset identifier that was assigned in response to the request. Furthermore, as shown in FIG. 6 and described herein, the dataset identifier returned to the UE 120 may be associated with current configurations and radio statistics in effect when the dataset identifier is assigned (e.g., configurations in effect at the UE 120, configurations in effect at the network node 110, radio statistics measured by the UE 120, and/or radio statistics that the network node 110 measures and indicates to the UE 120 at a time when the dataset identifier is assigned). Additionally, or alternatively, the network node 110 may initiate the dataset indexing or marking (e.g., when the network node 110 performs data collection in association with a network-side model or a network-part of a two-sided model associated with an AI/ML air interface use case). In such cases, as shown by reference number 630, the network node 110 may assign the dataset identifier and then transmit, to the UE 120, information indicating that a dataset identifier was assigned to a dataset collected by the network node 110.

In some aspects, as described herein, the dataset identifier that is assigned by the network node 110 and indicated to the UE 120 may include one or more attributes related to a data collection context (e.g., AI/ML functionality, a logical model, and/or a physical model) to enable LCM actions associated with an AI/ML air interface use case. For example, in some aspects, the one or more attributes of the dataset identifier may include a unique dataset ID, a cell identifier, a RAN area identifier, a tracking area identifier, a Coordinated Universal Time (UTC) time (e.g., a timestamp), a date, a start and stop time, a start and stop date, fixed reference location information (e.g., a latitude, longitude, elevation, and/or other unique location associated with a nearby landmark, building, or other reference location with a fixed and publicly accessible location), and/or an expiration time, among other examples. In some aspects, the network node 110 may autonomously obtain the dataset identifier that is assigned to the data collection context, or the network node 110 may coordinate with one or more other network entities (e.g., other RAN nodes, one or more core network devices, an OAM device, or the like) to obtain the dataset identifier. Furthermore, in some aspects, the dataset identifier assigned to the data collection context may be locally unique (e.g., unique among all dataset identifiers assigned by the network node 110) or globally unique (e.g., unique among all dataset identifiers assigned in a RAN, a public land mobile network (PLMN), a core network, or another suitable wireless network or portion of a wireless network that includes the network node 110).

As further shown in FIG. 6, and by reference numbers 640-1 and 640-2, the UE 120 and the network node 110 may each associate the dataset identifier with a data collection context to enable LCM actions associated with an AI/ML air interface use case (e.g., selecting, activating, deactivating, switching, and/or fallback for AI/ML functionality, a logical model, and/or a physical model associated with an AI/ML air interface use case). For example, in some aspects, the network node 110 may associate the dataset identifier with one or more configurations that were in effect at the network node 110 when the network node 110 assigned the dataset identifier, and the UE 120 may associate the dataset identifier with one or more configurations that were in effect at the UE 120 when the dataset identifier was provided by the network node 110. Furthermore, in some aspects, the UE 120 and the network node 110 may each associate the dataset identifier with one or more radio statistics at the time when the dataset identifier is assigned and indicated to the UE 120. For example, in some aspects, the radio statistics may be measured by the UE 120 and/or measured by the network node 110 (e.g., taking into consideration changes over time) and indicated to the UE 120.

In this way, as shown by reference number 650, dataset identifiers may be assigned to datasets that the UE 120 and/or the network node 110 collect over time, which may enable various LCM actions using the dataset identifiers. For example, at the network node 110, each dataset identifier may be associated with configurations that were in effect at the network node 110 at a time when the network node 110 assigned the dataset identifier (e.g., downlink beam shapes, downlink antenna patterns, configurations, and/or down-tilting, RU locations, a downlink multilayer precoder used to map data and/or control streams to layers in SU-MIMO and/or MU-MIMO, a downlink spatial filter used to map layers to physical antennas, and/or a transmit power, among other examples). Similarly, at the UE 120, each dataset identifier may be associated with configurations that were in effect at the UE 120 at the time when the dataset identifier was provided by the network node 110 (e.g., UE beam shapes, UE antenna patterns and/or configurations, an uplink multilayer precoder used to map data and/or control streams to layers, and/or an uplink spatial filter used to map layers to physical antennas, among other examples). Furthermore, at the UE 120 and the network node 110, each dataset identifier may be associated with radio statistics that relate to conditions of a wireless channel at the time when the network node 110 assigned the dataset identifier (e.g., a mean, median, k-percentile, range, and/or other suitable statistic or metric related to a SINR distribution, L1-RSRP measurements, a Rician factor or Rice distribution, a delay spread, and/or a Doppler spread, among other examples). In this way, the UE 120 and the network node 110 may use the dataset identifiers to align the respective configurations and radio statistics that were in effect at a particular time and enable LCM actions for an AI/ML air interface use case without indicating, conveying, or otherwise exposing their respective configurations.

For example, in cases where the UE 120 requests the dataset identifier during a data collection session and/or is collecting a dataset at a time that the network node 110 initiates assigning a dataset identifier, the UE 120 may train one or more UE-side AI/ML models and/or UE-side AI/ML functions using the dataset, and may then associate the one or more UE-side AI/ML models and/or UE-side AI/ML functions with the corresponding dataset identifier. Similarly, in cases where the network node 110 initiates the assignment of the dataset identifier during a data collection session and/or is collecting a dataset at a time when the UE 120 requests a dataset identifier, the network node 110 may train one or more network-side AI/ML models and/or network-side AI/ML functions using the dataset, and may then associate the one or more network-side AI/ML models and/or network-side AI/ML functions with the corresponding dataset identifier. In this way, when one or more LCM actions are initiated or otherwise taken with respect to a particular dataset identifier, the LCM actions may be applied to the one or more AI/ML models and/or AI/ML functions that are associated with the dataset identifier. Additionally, or alternatively, the network node 110 and/or the UE 120 may apply one or more configurations in accordance with the radio statistics and/or configurations associated with the dataset identifier (e.g., selecting configurations that are associated with radio statistics that are a closest match to current radio conditions).

For example, in some aspects, the UE 120 may provide signaling to the network node 110 to indicate that the UE 120 supports a UE-side AI/ML model and/or a UE-side AI/ML function that is valid for configurations of the network node 110, configurations of the UE 120, and/or radio statistics associated with a dataset identifier. For example, in some aspects, the UE 120 may indicate support for one or more dataset identifiers in a UE feature list associated with UE capability signaling, in a UCI command, or in other suitable signaling. In this way, indicating support for the one or more dataset identifiers may indicate that the UE-side AI/ML model and/or UE-side AI/ML functions are valid for the configurations of the network node 110, the configurations of the UE 120, and/or the radio statistics that are associated with the respective dataset identifiers. In some aspects, the network node 110 may then transmit, and the UE 120 may receive, signaling to apply one or more LCM actions (e.g., activation, deactivation, selection, switching, and/or fallback) for the UE-side AI/ML model and/or UE-side AI/ML functions, and the UE 120 may adjust one or more configurations of the UE 120 in accordance with the dataset identifier. Furthermore, the network node 110 may also apply one or more LCM actions to a corresponding network-side AI/ML model and/or network-side AI/ML functions, and/or adjust one or more configurations of the network node 110 in accordance with the dataset identifier.

In another example, the network node 110 may provide signaling to the UE 120 to indicate that the network node 110 supports and/or runs a network-side AI/ML model and/or a network-side AI/ML function that is valid for configurations of the network node 110, configurations of the UE 120, and/or radio statistics associated with a dataset identifier. For example, in some aspects, the network node 110 may indicate support for one or more dataset identifiers in a MAC-CE, in a DCI command, or in other suitable signaling. Additionally, or alternatively, the network node 110 may indicate support for one or more dataset identifiers in a broadcast message that targets multiple UEs (e.g., a system information block (SIB) that may be dedicated to AI/ML operations or shared with other system information). In some aspects, the UE 120 may then apply one or more LCM actions (e.g., activation, deactivation, selection, switching, and/or fallback) for the corresponding UE-side AI/ML model and/or UE-side AI/ML functions associated with the dataset identifier, and/or may adjust one or more configurations of the UE 120 in accordance with the dataset identifier.

In some aspects, a UE 120 that indicates support for a dataset identifier, receives an indication that the network node 110 supports a dataset identifier, and/or applies LCM actions associated with a dataset identifier may be the same as or different from a UE 120 that initially obtained the dataset identifier from the network node 110. For example, in some aspects, the UE 120 that obtains the dataset identifier may be a first (e.g., data collection) UE, and a second UE 120 that indicates support for a dataset identifier or applies LCM actions related to a dataset identifier may run one or more UE-side AI/ML models that were trained using the dataset(s) collected by the first UE 120. Similarly, the network node 110 that assigns the dataset identifier may be a first network node 110, and a second network node 110 that applies LCM actions related to a dataset identifier may run the one or more network-side AI/ML models that were trained using the dataset(s) collected by the first network node 110.

In some aspects, in addition to enabling LCM actions such as activation, deactivation, selection, switching, and/or fallback for one or more AI/ML models or AI/ML functions using the dataset identifiers assigned by the network node 110, a wireless network may support signaling to enable maintenance of the dataset identifiers by the UE 120 and/or the network node 110. For example, in some aspects, the network node 110 may decide to abort or otherwise disable a dataset identifier for any suitable reason, such as the network node 110 no longer using the configurations that were in effect when the dataset identifier was assigned. In such cases, the network node 110 may transmit an abort message (e.g., targeting a specific UE 120, targeting a specific group of UEs 120, or broadcasted to all UEs) to indicate that the dataset identifier is no longer valid. Additionally, or alternatively, the network node 110 may maintain a dataset identifier by replacing an existing dataset identifier with a new dataset identifier and/or modifying the attributes of an existing dataset identifier, in which case the network node 110 may transmit an appropriate UE-specific, group-specific, or broadcast message to update the dataset identifier and/or the attributes of the dataset identifier. Furthermore, similar techniques may be applied by a UE 120. For example, the UE 120 may transmit, and the network node 110 may receive, a message indicating that a dataset identifier is no longer valid and requesting that the network node 110 take appropriate action to abort, disable, or otherwise cancel the dataset identifier (e.g., transmitting a UE-specific, group-specific, or broadcast message to indicate that the dataset identifier is no longer valid). Additionally, or alternatively, the UE 120 may transmit a message to the network node 110 to request that the network node 110 replace an existing dataset identifier with a new dataset identifier and/or modify the attributes associated with one or more dataset identifiers.

As indicated above, FIG. 6 is provided as an example. Other examples may differ from what is described with regard to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with dataset identification for AI/ML air interface use cases.

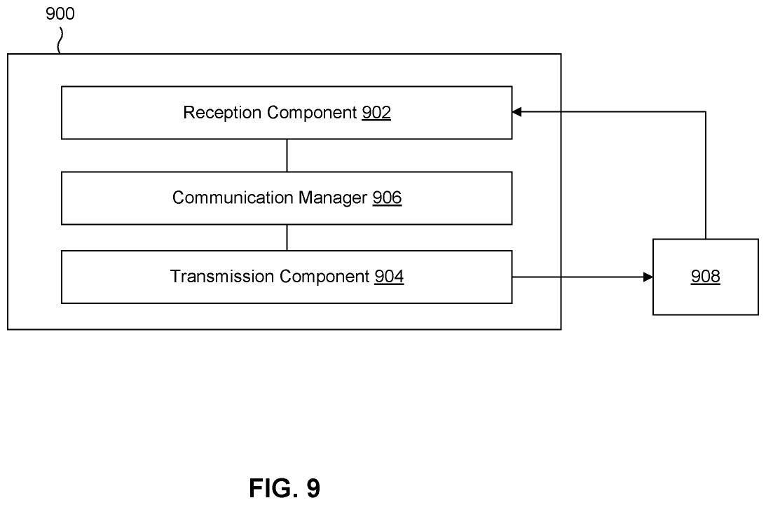

As shown in FIG. 7, in some aspects, process 700 may include collecting a dataset during a data collection session associated with an AI/ML air interface use case (block 710). For example, the UE (e.g., using communication manager 906, depicted in FIG. 9) may collect a dataset during a data collection session associated with an AI/ML air interface use case, as described above.

As further shown in FIG. 7, in some aspects, process 700 may include receiving, from a network node, a dataset identifier assigned to the data collection session associated with the AI/ML air interface use case (block 720). For example, the UE (e.g., using reception component 902 and/or communication manager 906, depicted in FIG. 9) may receive, from a network node, a dataset identifier assigned to the data collection session associated with the AI/ML air interface use case, as described above.

As further shown in FIG. 7, in some aspects, process 700 may include associating the dataset identifier with the dataset and with one or more configurations associated with the UE during the data collection session (block 730). For example, the UE (e.g., using communication manager 906, depicted in FIG. 9) may associate the dataset identifier with the dataset and with one or more configurations associated with the UE during the data collection session, as described above.

Process 700 may include additional aspects, such as any single aspect or any combination of aspects described below and/or in connection with one or more other processes described elsewhere herein.

In a first aspect, process 700 includes transmitting, to the network node, a request to assign the dataset identifier to the data collection session associated with the AI/ML air interface use case, wherein the dataset identifier is received from the network node in response to the request.

In a second aspect, alone or in combination with the first aspect, process 700 includes associating the dataset identifier with one or more radio statistics associated with a channel between the UE and the network node during the data collection session.

In a third aspect, alone or in combination with one or more of the first and second aspects, process 700 includes training one or more AI/ML models using the dataset, and associating the dataset identifier with the one or more AI/ML models.

In a fourth aspect, alone or in combination with one or more of the first through third aspects, process 700 includes transmitting, to the network node, information that indicates support for one or more UE-side features associated with the AI/ML air interface use case, wherein the support is valid for a set of attributes associated with the dataset identifier; receiving, from the network node, signaling to apply one or more LCM actions for the one or more UE-side features associated with the AI/ML air interface use case; and applying the one or more LCM actions for the one or more UE-side features associated with the AI/ML air interface use case in accordance with the set of attributes associated with the dataset identifier.

In a fifth aspect, alone or in combination with one or more of the first through fourth aspects, the support for the one or more UE-side features is indicated in a UE capability message or UCI.

In a sixth aspect, alone or in combination with one or more of the first through fifth aspects, process 700 includes receiving, from the network node, information that indicates support for one or more network-side features associated with the AI/ML air interface use case, wherein the support is valid for a set of attributes associated with the dataset identifier, and applying one or more LCM actions for one or more UE-side features associated with the AI/ML air interface use case in accordance with the set of attributes associated with the dataset identifier.

In a seventh aspect, alone or in combination with one or more of the first through sixth aspects, the support is indicated in a MAC-CE, a DCI message, or a broadcast message.

In an eighth aspect, alone or in combination with one or more of the first through seventh aspects, process 700 includes receiving, from the network node, a message to indicate that the dataset identifier is no longer valid for the AI/ML air interface use case.

In a ninth aspect, alone or in combination with one or more of the first through eighth aspects, process 700 includes receiving, from the network node, a message to modify a set of attributes associated with the dataset identifier.

In a tenth aspect, alone or in combination with one or more of the first through ninth aspects, process 700 includes transmitting, to the network node, a message to indicate that the dataset identifier is no longer valid for the AI/ML air interface use case.

In an eleventh aspect, alone or in combination with one or more of the first through tenth aspects, process 700 includes transmitting, to the network node, a message to modify a set of attributes associated with the dataset identifier.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with dataset identification for AI/ML air interface use cases.

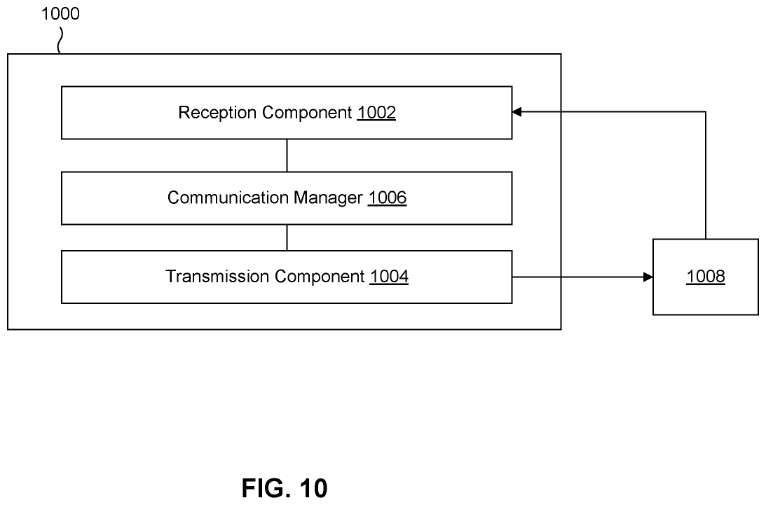

As shown in FIG. 8, in some aspects, process 800 may include assigning a dataset identifier to a dataset collected during a data collection session associated with an AI/ML air interface use case (block 810). For example, the network node (e.g., using communication manager 1006, depicted in FIG. 10) may assign a dataset identifier to a dataset collected during a data collection session associated with an AI/ML air interface use case, as described above.

As further shown in FIG. 8, in some aspects, process 800 may include transmitting, to a UE, the dataset identifier (block 820). For example, the network node (e.g., using transmission component 1004 and/or communication manager 1006, depicted in FIG. 10) may transmit, to a UE, the dataset identifier, as described above.

As further shown in FIG. 8, in some aspects, process 800 may include associating the dataset identifier with the dataset and with one or more configurations associated with the network node during the data collection session (block 830). For example, the network node (e.g., using communication manager 1006, depicted in FIG. 10) may associate the dataset identifier with the dataset and with one or more configurations associated with the network node during the data collection session, as described above.

Process 800 may include additional aspects, such as any single aspect or any combination of aspects described below and/or in connection with one or more other processes described elsewhere herein.

In a first aspect, process 800 includes receiving, from the UE, a request to assign the dataset identifier to the data collection session associated with the AI/ML air interface use case, wherein the dataset identifier is assigned and transmitted to the UE in response to the request.

In a second aspect, alone or in combination with the first aspect, process 800 includes associating the dataset identifier with one or more radio statistics associated with a channel between the UE and the network node during the data collection session.

In a third aspect, alone or in combination with one or more of the first and second aspects, process 800 includes training one or more AI/ML models using the dataset, and associating the dataset identifier with the one or more AI/ML models.

In a fourth aspect, alone or in combination with one or more of the first through third aspects, process 800 includes receiving, from the UE, information that indicates support for one or more UE-side features associated with the AI/ML air interface use case, wherein the support is valid for a set of attributes associated with the dataset identifier, and transmitting, to the UE, signaling to apply one or more LCM actions for the one or more UE-side features associated with the AI/ML air interface use case in accordance with the set of attributes associated with the dataset identifier.

In a fifth aspect, alone or in combination with one or more of the first through fourth aspects, the support for the one or more UE-side features is indicated in a UE capability message or UCI.

In a sixth aspect, alone or in combination with one or more of the first through fifth aspects, process 800 includes transmitting, to the UE, information that indicates support for one or more network-side features associated with the AI/ML air interface use case, wherein the support is valid for a set of attributes associated with the dataset identifier.

In a seventh aspect, alone or in combination with one or more of the first through sixth aspects, the support is indicated in a MAC-CE, a DCI message, or a broadcast message.

In an eighth aspect, alone or in combination with one or more of the first through seventh aspects, process 800 includes transmitting, to the UE, a message to indicate that the dataset identifier is no longer valid for the AI/ML air interface use case.

In a ninth aspect, alone or in combination with one or more of the first through eighth aspects, process 800 includes transmitting, to the UE, a message to modify a set of attributes associated with the dataset identifier.

In a tenth aspect, alone or in combination with one or more of the first through ninth aspects, process 800 includes receiving, from the UE, a message to indicate that the dataset identifier is no longer valid for the AI/ML air interface use case.

In an eleventh aspect, alone or in combination with one or more of the first through tenth aspects, process 800 includes receiving, from the UE, a message to modify a set of attributes associated with the dataset identifier.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may collect a dataset during a data collection session associated with an AI/ML air interface use case. The reception component 902 may receive, from a network node, a dataset identifier assigned to the data collection session associated with the AI/ML air interface use case. The communication manager 906 may associate the dataset identifier with the dataset and with one or more configurations associated with the UE during the data collection session.

The transmission component 904 may transmit, to the network node, a request to assign the dataset identifier to the data collection session associated with the AI/ML air interface use case, wherein the dataset identifier is received from the network node in response to the request.

The communication manager 906 may associate the dataset identifier with one or more radio statistics associated with a channel between the UE and the network node during the data collection session.

The communication manager 906 may train one or more AI/ML models using the dataset. The communication manager 906 may associate the dataset identifier with the one or more AI/ML models.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may assign a dataset identifier to a dataset collected during a data collection session associated with an AI/ML air interface use case. The transmission component 1004 may transmit, to a UE, the dataset identifier. The communication manager 1006 may associate the dataset identifier with the dataset and with one or more configurations associated with the network node during the data collection session.

The reception component 1002 may receive, from the UE, a request to assign the dataset identifier to the data collection session associated with the AI/ML air interface use case, wherein the dataset identifier is assigned and transmitted to the UE in response to the request.

The communication manager 1006 may associate the dataset identifier with one or more radio statistics associated with a channel between the UE and the network node during the data collection session.

The communication manager 1006 may train one or more AI/ML models using the dataset. The communication manager 1006 may associate the dataset identifier with the one or more AI/ML models.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: collecting a dataset during a data collection session associated with an AI/ML air interface use case; receiving, from a network node, a dataset identifier assigned to the data collection session associated with the AI/ML air interface use case; and associating the dataset identifier with the dataset and with one or more configurations associated with the UE during the data collection session.

Aspect 2: The method of Aspect 1, further comprising: transmitting, to the network node, a request to assign the dataset identifier to the data collection session associated with the AI/ML air interface use case, wherein the dataset identifier is received from the network node in response to the request.

Aspect 3: The method of any of Aspects 1-2, further comprising: associating the dataset identifier with one or more radio statistics associated with a channel between the UE and the network node during the data collection session.

Aspect 4: The method of any of Aspects 1-3, further comprising: training one or more AI/ML models using the dataset; and associating the dataset identifier with the one or more AI/ML models.

Aspect 5: The method of any of Aspects 1-4, further comprising: transmitting, to the network node, information that indicates support for one or more UE-side features associated with the AI/ML air interface use case, wherein the support is valid for a set of attributes associated with the dataset identifier; receiving, from the network node, signaling to apply one or more LCM actions for the one or more UE-side features associated with the AI/ML air interface use case; and applying the one or more LCM actions for the one or more UE-side features associated with the AI/ML air interface use case in accordance with the set of attributes associated with the dataset identifier.

Aspect 6: The method of Aspect 5, wherein the support for the one or more UE-side features is indicated in a UE capability message or UCI.

Aspect 7: The method of any of Aspects 1-6, further comprising: receiving, from the network node, information that indicates support for one or more network-side features associated with the AI/ML air interface use case, wherein the support is valid for a set of attributes associated with the dataset identifier; and applying one or more LCM actions for one or more UE-side features associated with the AI/ML air interface use case in accordance with the set of attributes associated with the dataset identifier.

Aspect 8: The method of Aspect 7, wherein the support is indicated in a MAC-CE, a DCI message, or a broadcast message.

Aspect 9: The method of any of Aspects 1-8, further comprising: receiving, from the network node, a message to indicate that the dataset identifier is no longer valid for the AI/ML air interface use case.

Aspect 10: The method of any of Aspects 1-9, further comprising: receiving, from the network node, a message to modify a set of attributes associated with the dataset identifier.

Aspect 11: The method of any of Aspects 1-10, further comprising: transmitting, to the network node, a message to indicate that the dataset identifier is no longer valid for the AI/ML air interface use case.

Aspect 12: The method of any of Aspects 1-11, further comprising: transmitting, to the network node, a message to modify a set of attributes associated with the dataset identifier.

Aspect 13: A method of wireless communication performed by a network node, comprising: assigning a dataset identifier to a dataset collected during a data collection session associated with an AI/ML air interface use case; transmitting, to a UE, the dataset identifier; and associating the dataset identifier with the dataset and with one or more configurations associated with the network node during the data collection session.

Aspect 14: The method of Aspect 13, further comprising: receiving, from the UE, a request to assign the dataset identifier to the data collection session associated with the AI/ML air interface use case, wherein the dataset identifier is assigned and transmitted to the UE in response to the request.

Aspect 15: The method of any of Aspects 13-14, further comprising: associating the dataset identifier with one or more radio statistics associated with a channel between the UE and the network node during the data collection session.

Aspect 16: The method of any of Aspects 13-15, further comprising: training one or more AI/ML models using the dataset; and associating the dataset identifier with the one or more AI/ML models.

Aspect 17: The method of any of Aspects 13-16, further comprising: receiving, from the UE, information that indicates support for one or more UE-side features associated with the AI/ML air interface use case, wherein the support is valid for a set of attributes associated with the dataset identifier; and transmitting, to the UE, signaling to apply one or more LCM actions for the one or more UE-side features associated with the AI/ML air interface use case in accordance with the set of attributes associated with the dataset identifier.

Aspect 18: The method of Aspect 17, wherein the support for the one or more UE-side features is indicated in a UE capability message or UCI.

Aspect 19: The method of any of Aspects 13-18, further comprising: transmitting, to the UE, information that indicates support for one or more network-side features associated with the AI/ML air interface use case, wherein the support is valid for a set of attributes associated with the dataset identifier.

Aspect 20: The method of Aspect 19, wherein the support is indicated in a MAC-CE, a DCI message, or a broadcast message.

Aspect 21: The method of any of Aspects 13-20, further comprising: transmitting, to the UE, a message to indicate that the dataset identifier is no longer valid for the AI/ML air interface use case.

Aspect 22: The method of any of Aspects 13-21, further comprising: transmitting, to the UE, a message to modify a set of attributes associated with the dataset identifier.

Aspect 23: The method of any of Aspects 13-22, further comprising: receiving, from the UE, a message to indicate that the dataset identifier is no longer valid for the AI/ML air interface use case.

Aspect 24: The method of any of Aspects 13-23, further comprising: receiving, from the UE, a message to modify a set of attributes associated with the dataset identifier.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A method of wireless communication performed by a user equipment (UE), comprising:
collecting a dataset during a data collection session associated with an artificial intelligence or machine learning (AI/ML) air interface use case;
receiving, from a network node, a dataset identifier assigned to the data collection session associated with the AI/ML air interface use case; and
associating the dataset identifier with the dataset and with one or more configurations associated with the UE during the data collection session.

2. The method of claim 1, further comprising:
transmitting, to the network node, a request to assign the dataset identifier to the data collection session associated with the AI/ML air interface use case, wherein the dataset identifier is received from the network node in response to the request.

3. The method of claim 1, further comprising:
associating the dataset identifier with one or more radio statistics associated with a channel between the UE and the network node during the data collection session.

4. The method of claim 1, further comprising:
training one or more AI/ML models using the dataset; and
associating the dataset identifier with the one or more AI/ML models.

5. The method of claim 1, further comprising:
transmitting, to the network node, information that indicates support for one or more UE-side features associated with the AI/ML air interface use case, wherein the support is valid for a set of attributes associated with the dataset identifier;
receiving, from the network node, signaling to apply one or more lifecycle management (LCM) actions for the one or more UE-side features associated with the AI/ML air interface use case; and
applying the one or more LCM actions for the one or more UE-side features associated with the AI/ML air interface use case in accordance with the set of attributes associated with the dataset identifier.

6. The method of claim 5, wherein the support for the one or more UE-side features is indicated in a UE capability message or uplink control information (UCI).

7. The method of claim 1, further comprising:
receiving, from the network node, information that indicates support for one or more network-side features associated with the AI/ML air interface use case, wherein the support is valid for a set of attributes associated with the dataset identifier; and
applying one or more lifecycle management (LCM) actions for one or more UE-side features associated with the AI/ML air interface use case in accordance with the set of attributes associated with the dataset identifier.

8. The method of claim 7, wherein the support is indicated in a medium access control (MAC) control element (MAC-CE), a downlink control information (DCI) message, or a broadcast message.

9. The method of claim 1, further comprising:
receiving, from the network node, a message to indicate that the dataset identifier is no longer valid for the AI/ML air interface use case.

10. The method of claim 1, further comprising:
receiving, from the network node, a message to modify a set of attributes associated with the dataset identifier.

11. The method of claim 1, further comprising:
transmitting, to the network node, a message to indicate that the dataset identifier is no longer valid for the AI/ML air interface use case.

12. The method of claim 1, further comprising:
transmitting, to the network node, a message to modify a set of attributes associated with the dataset identifier.

13. A user equipment (UE) for wireless communication, comprising:
one or more memories; and
one or more processors, coupled to the one or more memories, configured to cause the UE to:
collect a dataset during a data collection session associated with an artificial intelligence or machine learning (AI/ML) air interface use case;
receive, from a network node, a dataset identifier assigned to the data collection session associated with the AI/ML air interface use case; and
associate the dataset identifier with the dataset and with one or more configurations associated with the UE during the data collection session.

14. The UE of claim 13, wherein the one or more processors are further configured to cause the UE to:
transmit, to the network node, a request to assign the dataset identifier to the data collection session associated with the AI/ML air interface use case, wherein the dataset identifier is received from the network node in response to the request.

15. The UE of claim 13, wherein the one or more processors are further configured to cause the UE to:
associate the dataset identifier with one or more radio statistics associated with a channel between the UE and the network node during the data collection session.

16. The UE of claim 13, wherein the one or more processors are further configured to cause the UE to:
train one or more AI/ML models using the dataset; and
associate the dataset identifier with the one or more AI/ML models.

17. The UE of claim 13, wherein the one or more processors are further configured to cause the UE to:
receive, from the network node, information that indicates support for one or more network-side features associated with the AI/ML air interface use case, wherein the support is valid for a set of attributes associated with the dataset identifier; and
apply one or more lifecycle management (LCM) actions for one or more UE-side features associated with the AI/ML air interface use case in accordance with the set of attributes associated with the dataset identifier.

18. The UE of claim 13, wherein the one or more processors are further configured to cause the UE to:
receive, from the network node, one or more of a message to indicate that the dataset identifier is no longer valid for the AI/ML air interface use case or a message to modify a set of attributes associated with the dataset identifier.

19. The UE of claim 13, wherein the one or more processors are further configured to cause the UE to:
transmit, to the network node, one or more of a message to indicate that the dataset identifier is no longer valid for the AI/ML air interface use case or a message to modify a set of attributes associated with the dataset identifier.

20. An apparatus for wireless communication, comprising:
means for collecting a dataset during a data collection session associated with an artificial intelligence or machine learning (AI/ML) air interface use case;
means for receiving, from a network node, a dataset identifier assigned to the data collection session associated with the AI/ML air interface use case; and
means for associating the dataset identifier with the dataset and with one or more configurations associated with the apparatus during the data collection session.
